(19) United States
(12) Patent Application Publication
(10) Pub. No.: US 2019/0235959 A1
(43) Pub. Date: Aug. 1, 2019

(54) Proactive Node Preference Changing in a Storage Controller

(71) Applicant: International Business Machines Corporation, Armonk, NY (US)

(72) Inventors: Alexander H. Ainscow, Winchester (GB); Christopher W. Bulmer, Hursley (GB); Andrew D. Martin, Hampshire (GB); Timothy A. Moran, Southampton (GB)

(21) Appl. No.: 15/883,310

(22) Filed: Jan. 30, 2018

(51) Int. Cl. G06F 11/14; H04L 29/08; G06F 11/20; G06F 9/455

(52) U.S. Cl. CPC G06F 11/1425; H04L 67/1097; G06F 9/45558; G06F 11/2087; G06F 11/1484

(57) ABSTRACT

Disclosed is a computer-implemented method in a storage controller of changing a preferred node from a first node to a second node, comprising: receiving a notification of a request to remove the first node; reporting ports on the first node as non-preferred instead of reporting them as preferred; reporting ports on the second node as preferred instead of reporting them as non-preferred; compiling a target port groups report for each of the first node and the second node; and raising an asymmetric access state changed unit attention notification.

### BACKGROUND

The present invention relates to storage controllers having a plurality of nodes, and more specifically to removing a node from a storage controller whilst minimizing the effects on a host accessing logical units associated with the storage controller.

A storage controller may comprise an interface to a host computer system, hereinafter referred to as a host, of virtualized disks, or Logical Units (LUN). In order to provide redundancy, the storage controller may comprise a plurality of nodes, each of the nodes having paths to access one or more of the virtualized disks through one or more target ports on each node. If one of the nodes is removed for any reason, the host will still have access to its LUNs through the remaining nodes in the storage controller. Any outstanding commands that were lost on the removal of one node can be reissued by the host through the remaining nodes in the storage controller.

In a prior art storage controller using Asymmetric Logical Unit Access (ALUA) a host may access a LUN through more than one of the plurality of nodes, with that node that is preferred for access to particular LUNs by particular hosts being indicated. However, at any given time, for any given LUN, only one of the nodes is in an Active/Optimized state and providing optimal performance for that particular LUN. An example of ALUA is a SCSI controller device with two separated controllers where all target ports on one controller are in the same primary target port asymmetric access state with respect to a logical unit and are members of the same primary target port group. Target ports on the other controller are members of another primary target port group. The behavior of each primary target port group may be different with respect to a logical unit, but all members of a single primary target port group are always in the same primary target port group asymmetric access state with respect to a logical unit.

A storage controller can indicate that a particular node is a preferred node for a particular host to access a particular LUN by grouping the target ports on that particular node together in a target port group that has an Active/Optimized asymmetric access state. Target ports on other nodes through which LUN access by the host is possible but not preferred are grouped together in target port groups with Active/Non-optimized asymmetric access state. Any attempt by a host to access a LUN through a node that is in an Active/Non-Optimized state may result in a decreased throughput or indeed may result in the LUN being inaccessible through that node. The use of ALUA allows the storage controller to present to the host preferred and non-preferred paths to a LUN, for example for load balancing purposes, when to the host, the two paths would otherwise appear equivalent.

Since a host may access a LUN through more than one of the plurality of nodes, any of the plurality of nodes through which the host may access the LUN may be removed without removing access for the host to the LUN through the remaining one or ones of the plurality of nodes. However, if a node is simply removed, any commands that the host was in the process of sending to the LUN through the node being removed will be interrupted and will need to be resent. This may result in a delay in the command being executed. It may also result in a loss of commands or a disruption of access by the host to the LUN. Further, when a node is being returned to the storage controller, a host may attempt to send commands to a LUN through the node which will result in a delay in the execution of the commands until the node is ready to process the commands. Another node in the storage controller is likely to be able to process the commands without queuing them and so without delay.

U.S. Pat. No. 8,626,967 B1 discloses host-based failover software on attached hosts to achieve port failover in the event of a failure of a single physical connection or a storage processor. However, this approach requires each attached host to have correctly configured failover software installed. This can be expensive and extremely inconvenient. It further discloses a technique for use in managing a port failover in a data storage system. The technique leverages the technology Fibre Channel N-Port ID Virtualization (“NPIV”) in a Fibre Channel switch for providing port failover capability. The storage system can dynamically move a failed port's identity to another functioning port using NPIV. This can cause the Fibre Channel switch to redirect the traffic previously destined to a port to another port.

U.S. Pat. No. 8,060,775 B1 discloses a method in which, upon detecting a path failure of an optimized path, it immediately switches from using the optimized path to using an unoptimized path. The optimized and unoptimized paths may couple a cluster of host servers to the storage system. Upon optimized path failure to one or more of the hosts, the cluster may immediately switch from using the optimized path to the unoptimized path without impacting the operation of any applications executing on the hosts in the cluster.

### SUMMARY

According to an embodiment of the invention, a computer-implemented method in a storage controller of changing a preferred node from a first node to a second node, comprises: receiving a notification of a request to remove the first node; reporting ports on the first node as non-preferred instead of reporting them as preferred; reporting ports on the second node as preferred instead of reporting them as non-preferred; compiling a target port groups report for each of the first node and the second node; and raising an “Asymmetric Access State Changed” unit attention notification. Embodiments of the present invention provide the advantage of being responsive to an anticipated future state of the storage controller, rather than a current state of the storage controller. The target port group is modified so as to minimize the chance of disruption during a scheduled removal of the first node by diverting traffic to the second node.

In a preferred embodiment, wherein access to logical units (LUNs) presented by the storage controller supports Asymmetric Logical Unit Access and wherein each target port group corresponding to ports on the first node and the second node have different asymmetric access states. This allows maximum compatibility with existing hosts as the storage controller can indicate preferred paths to LUNs by setting appropriate asymmetric access states.

Embodiments of the invention provide a storage controller comprising: a first node and a second node, each of the first node and the second node having a plurality of ports; the storage controller receiving a notification of a request to remove the first node; the storage controller changing a preferred node from the first node to the second node by: reporting ports on the first node as non-preferred instead of reporting them as preferred; reporting ports on the second node as preferred instead of reporting them as non-preferred; compiling a target port groups report for each of the first node and the second node; and raising an “Asymmetric Access State Changed” unit attention notification.

Embodiments of the invention also provide a computer program product for changing a preferred node in a storage controller from a first node to a second node, the computer program product comprising: a computer readable storage medium having program instructions embodied therewith, the program instructions executable by a computer to cause the computer to: receive a notification of a request to remove the first node; report ports on the first node as non-preferred instead of reporting them as preferred; report ports on the second node as preferred instead of reporting them as non-preferred; compile a target port groups report for each of the first node and the second node; and raising an “Asymmetric Access State Changed” unit attention notification.

### BRIEF DESCRIPTION OF THE DRAWINGS

Preferred embodiments of the present invention will now be described in more detail, by way of example only, with reference to the accompanying drawings, in which:

FIG. 1 is a block diagram of apparatus in which embodiments of the present invention may be implemented;

FIG. 2 is a flow chart of a computer-implemented method of changing a preferred node in a storage controller from a first node to a second node according to an embodiment of the present invention;

FIG. 3 is a flow chart of steps performed in a host in conjunction with the embodiment of FIG. 2;

FIG. 4 is a flow chart of the steps performed by the storage controller after the host has completed the steps of FIG. 3;

FIG. 5 is a flow chart of steps performed in the event that removal of a first node is interrupted; and

FIG. 6 is a block diagram of a computer system in which embodiments of the present invention may be implemented.

### DETAILED DESCRIPTION

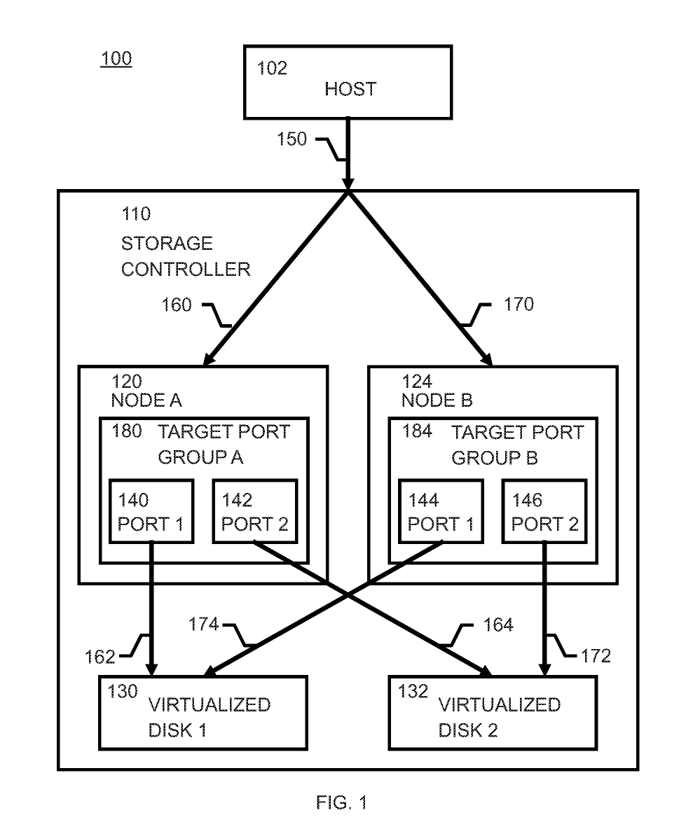

FIG. 1 is a block diagram of apparatus 100 in which embodiments of the present invention may be implemented. Storage controller 110 receives commands 150 from one or more hosts 102 as well as returning results (not shown in FIG. 1) to one or more hosts 102. Commands 150 may be directed 160 to a first node A 120 or directed 170 to a second node B 124. In embodiments, hosts 102 may communicate with a single storage controller 110 or with multiple storage controllers 110. Storage controller 110 may comprise two or more nodes 120, 124, the quantity of two nodes 120, 124 in FIG. 1 being shown for exemplary purposes only. Embodiments of the present invention in which a storage controller 110 comprises only a single node 120, 124 would not be advantageous.

Each of the nodes 120, 124 in the storage controller 110 has one or more paths 162-174 from ports 140-146 to access one or more virtualized disks 130, 132 (or LUNS). Embodiments of the invention may comprise any number of virtualized disks 130, 132 ranging from a single virtualized disk 130 to a system having a large number of virtualized disks 130, 132. In the example of FIG. 1, virtualized disk 1 130 is accessible from node A 120 through port 1 140 via path 162 and from node B 124 through port 1 144 via path 174. Similarly, virtualized disk 2 132 is accessible from node A 120 through port 2 142 via path 164 and from node B 124 through port 2 146 via path 172. In embodiments, each of the virtualized disks 130, 132 may be accessible from each node 120, 124 or there may be any combination of virtualized disks 130, 132 accessible from any combination of nodes 120, 124. For example, path 174 may not be present meaning that virtualized disk 1 130 is not accessible from node B 124. In practice, each virtualized disk 130, 132 should be accessible from at least two nodes 120, 124, so there should only be missing paths in a storage controller 110 having three or more nodes 120, 124.

Embodiments of the storage controller 110 FIG. 1 are typically referred to as permitting Asymmetric Logical Unit (LUN) Access (ALUA) in which the host 102 may access each LUN (or virtualized disk 130, 132) through more than one of the plurality of nodes 120, 124. However, at any given time, for any given virtualized disk 130, 132, only one of the nodes 120, 124 is in an Active/Optimized state and providing optimal performance for a particular virtualized disk 130, 132. For the given virtualized disk 130, 132, nodes 120, 124, other than the one node 120, 124 which are in an Active/Optimized state, are in an Active/Non-Optimized state. Any attempt by a host 102 to access a virtualized disk 130, 132 through a node 120, 124 that are in an Active/Non-Optimized state may result in a decreased throughput or indeed may result in the virtualized disk 130, 132 being inaccessible through that node 120, 124. Information as to which paths 162-174 between nodes 120, 124 and virtualized disks 130, 132 through ports 140-146 are available and are preferred or non-preferred is contained in a “Target Port Group Report” associated with each of the nodes 120, 124. The use of ALUA allows the storage controller 110 to present to the host 102 preferred and non-preferred paths 162-174 to a virtualized disk 130, 132, for example, for load balancing purposes, when to the host 102, the preferred and non-preferred paths 162-174 appear equivalent. In these embodiments, access to the storage controller is through Asymmetric Logical Unit Access.

Asymmetric Logical Unit Access occurs when the access characteristics of one port 140-146 differs from those of another port 140-146. Target devices with target ports 140-146 implemented in separate physical units may designate differing levels of access for the target ports 140-146 associated with each virtualized disk 130, 132. Whilst commands and task management functions may be routed to a virtualized disk 130, 132 through any target port 140-146, the performance achieved may not be optimal, and the allowable command set may be less complete than when the same commands and task management functions are routed through a different target port 140-146. In addition, some target ports 140-146 may be in a state, for example, offline, that is unique to that target port 140-146. If a failure on a path 162-174 to one target port 140-146 is detected, the target device may perform automatic internal reconfiguration to make a virtualized disk 130, 132 accessible from a different set of target ports 140-146 or may be instructed by a host 102 to make a virtualized disk 130, 132 accessible from a different set of target ports 140-146.

A target port 140-146 characteristic called primary target port asymmetric access state defines properties of a target port 140-146 and the allowable command set for a virtualized disk 130, 132 when commands and task management functions are routed through the target port 140-146 maintaining that state.

A primary target port group 180, 184 is defined as a set of target ports 140-146 that are in the same primary target port asymmetric access state at all times, that is, a change in one target port's primary target port asymmetric access state implies an equivalent change in the primary target port asymmetric access state of all target ports 140-146 in the same primary target port group 180, 184. A primary target port group asymmetric access state is defined as the primary target port asymmetric access state common to the set of target ports 140-146 in a primary target port group 180, 184. One target port 140-146 is a member of at most one primary target port group 180, 184 for a virtualized disk group.

A virtualized disk 130, 132 may have commands and task management functions routed through multiple primary target port groups 180, 184. Virtualized disks 130, 132 support asymmetric logical unit access if different primary target port groups 180, 184 may be in different primary target port group asymmetric access states. Support for asymmetric logical unit access should not affect how a device server responds to unsupported commands or how the task manager responds to unsupported task management functions.

An example of asymmetric logical unit access is a storage controller 110 with two separated nodes 120, 124 where all target ports 140, 142 on one node 120 are in the same primary target port asymmetric access state with respect to a virtualized disk 130, 132 and are members of the same primary target port group 180. Target ports 144, 146 on the other node 124 controller are members of another primary target port group 184. The behavior of each primary target port group 180, 184 may be different with respect to a virtualized disk 130, 132, but all members of a single primary target port group 180, 184 are always in the same primary target port group asymmetric access state with respect to a virtualized disk 130, 132.

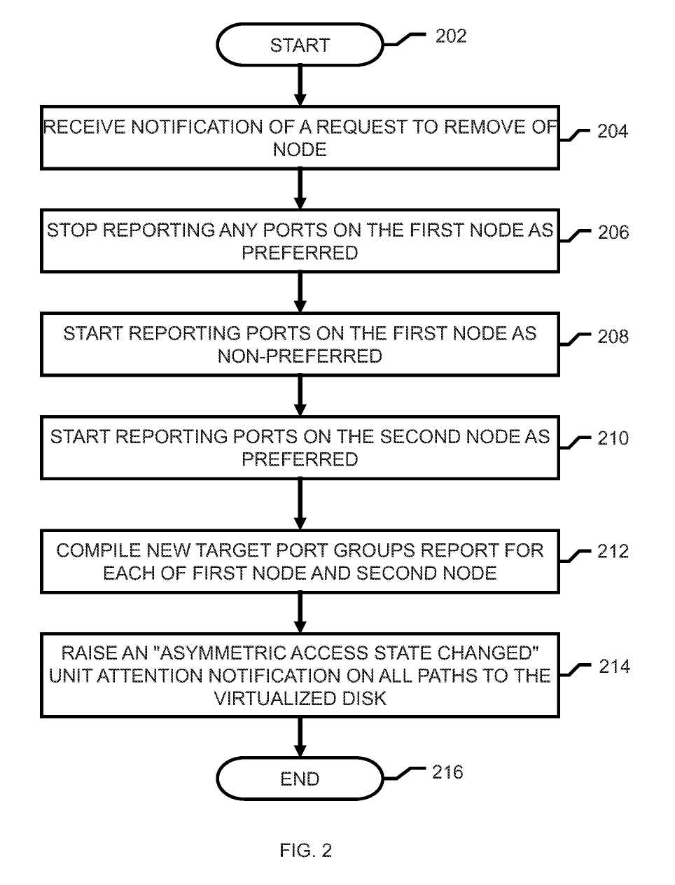

FIG. 2 is a flow chart of a computer-implemented method of changing a preferred node in a storage controller from a first node to a second node, according to an embodiment of the present invention. The computer-implemented method starts at step 202. At step 204, a notification of a request to remove a first node 120 is received. In an embodiment, a notice of removal of a node 120, 124 is received because a software upgrade is scheduled for that node 120, 124. When such a software upgrade occurs, typically a first node 120 is removed, the software upgrade is performed on the first node 120 and the first node 120 is reinstated on a controlled schedule. Whilst the software update is being performed on the first node 120, requests from a host 102 are handled by the second node 124. A second node 124 is then removed, the software upgrade is performed on the second node 124 and the second node 124 is reinstated on a controlled schedule. Whilst the software update is being performed on the first node 120, requests from a host 102 are handled by the second node 124.

In another embodiment, removal of a node 120, 124 may have been manually requested through the use of, for example, a Command Line Interface (CLI) command. The actual removal of the node 120, 124 may be scheduled to occur at some time after the CLI command was entered. Examples of commands which may be executed through the CLI in order to remove a node 120, 124 include “rmnode” or “rmnodecanister” to delete a node 120, 124 from a clustered system or “satask startservice” to cause a node 120, 124 to go into a service state. Normally these commands are not forced and thus host 102 I/O that is in process should not be interrupted, although any I/O that was being handled by a node at the time of its removal will need to be resubmitted by the host to the remaining node or nodes. Embodiments of the present invention provide improvements to conventional systems to ensure that host 102 I/O that is in process is allowed to complete, with subsequent I/O issued to other nodes 120, 124 before the removal of the first node 120 is processed. If a direct command is forced, that is by the addition of a “-force” option with the command, then a user accepts that host 102 I/O may be interrupted and so embodiments of the present invention need not be used and thus the node 120, 124 may be removed without changing the preferred or non-preferred state of the nodes or changing the asymmetric access state of the target port groups containing ports 140-146. In yet another embodiment, the request to remove a node 120, 124 may be an indirect result of a user-initiated command, such as a command to upgrade or downgrade a cluster of nodes 120, 124 which will trigger the sequential removal and reinstatement of nodes as the code level of the nodes 120, 124 is updated.

Further, a node 120, 124 may be removed automatically by a storage controller 110, for example, as part of an automatic upgrade, or to resolve performance issues that could be addressed by rerouting I/O and restarting a node 120, 124, or in response to an error condition.

At step 206, any ports 140, 142 on the first node 120 are no longer reported as preferred. As described above, typically, this means that node 120 was preferred and the target port group containing ports 140, 142 was reported with an Active/Optimized asymmetric access state, but is no longer reported as such. At step 208, ports 140, 142 on the first node 120 are now reported as non-preferred. Also as described above, typically, this means that node 120 is now non-preferred and the target port group containing ports 140, 142 is now reported with an Active/Non-optimized asymmetric access state. At step 210, ports 144, 146 on the second node 124 are now reported as preferred. Typically, this means that node 124 is the newly preferred node for accessing this virtualized disk 130, 132, whilst the node 120 that would normally be the preferred node 120 for accessing the virtualized disk 130, 132 which is expected to be removed or otherwise out of action and the target port group containing target ports 144, 146 is now reported with an Active/Optimized asymmetric access state. Previously, the ports 144, 146 on the second node 124 were reported as non-preferred. The reporting of these ports as preferred or non-preferred is done by setting the value of the ASYMMETRIC ACCESS STATE field in a descriptor for the target port group containing those ports as Active/Optimized, for ports on the preferred node, or Active/Non-optimized, for ports on the non-preferred node. This will be described in more detail with reference to Table 6.

At step 212, a new Target Ports Group Report is compiled for each of the first node 120 and the second node 124. At step 214, an “Asymmetric Access State Changed” unit attention notification is raised on all paths to the virtualized disks 130, 132. This indicates to a host 102 that there has been a change to the ASYMMETRIC ACCESS STATE field, described later with reference to Table 6. The computer-implemented method ends at step 216.

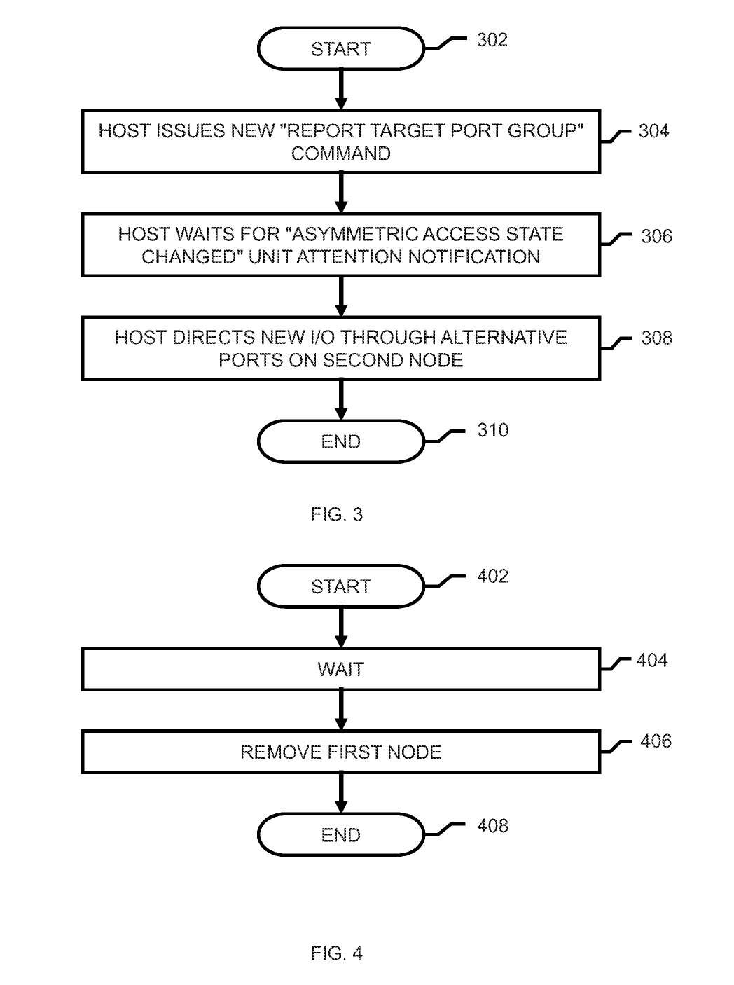

FIG. 3 is a flow chart of steps performed in a host in conjunction with the embodiment of FIG. 2. The computer-implemented method starts at step 302. At step 304, host 102 issues a new “Report Target Port Group” command. The “Report Target Port Group” command is issued by the host 102 sending a Command Data Block (CDB) to the storage controller 110.

The REPORT TARGET PORT GROUPS command (see Table 1 below) is one of the Primary Commands defined in the SCSI standard. The operation code for this command is A3 h and the service action is 0Ah. The host 102 issues a REPORT TARGET PORT GROUPS command to request the storage controller 110 to which the command is addressed to return target port group information. The host 102 issues the command by sending the CDB shown in Table 1 below.

TABLE 1

| | Bit | | | | | | | |
|---|---|---|---|---|---|---|---|---|
| Byte | 7 | 6 | 5 | 4 | 3 | 2 | 1 | 0 |
| 0 | OPERATION CODE (A3h) | | | | | | | |
| 1 | PARAMETER DATA | | | SERVICE ACTION (0Ah) | | | | |
| | FORMAT (See Table 2) | | | | | | | |
| 2 | Reserved | | | | | | | |
| . . . | | | | | | | | |
| 5 | | | | | | | | |
| 6 | (MSB) | ALLOCATION LENGTH | | | | | | (LSB) |
| . . . | | | | | | | | |
| 9 | | | | | | | | |

| | |
|---|---|
| 10 | Reserved |
| 11 | CONTROL |

In Table 1, the PARAMETER DATA FORMAT field (see Table 2 below) specifies the format requested by the host 102 for the parameter data returned by the REPORT TARGET PORT GROUPS command from the storage controller 110. The ALLOCATION LENGTH field specifies the maximum number of bytes or blocks that an application client has allocated in the Data-In Buffer. The possible values for this field are shown in Table 2 below. In this description, two of the possible values are described, both of which are usable in embodiments of the present invention. However, the present invention may be used not just with two formats of data, but with just one format of data, or with more than two formats of data.

TABLE 2

| Code | Description |
|---|---|
| 000b | Length only header parameter data format (See Table 3) |
| 001b | Extended header parameter data format (See Table 4) |
| 010b to 111b | Reserved |

In Table 2, the first listed format of data, the length only header format of the parameter data, for the REPORT TARGET PORT GROUPS command is shown in Table 3 below.

TABLE 3

| | Bit | | | | | | | |
|---|---|---|---|---|---|---|---|---|
| Byte | 7 | 6 | 5 | 4 | 3 | 2 | 1 | 0 |
| 0 | (MSB) | RETURN DATA LENGTH (n-3) | | | | | | (LSB) |
| . . . | | | | | | | | |
| 3 | | | | | | | | |
| | Target port group descriptor list | | | | | | | |
| 4 | Target port group descriptor (see Table 5) [first] | | | | | | | |
| . . . | | | | | | | | |
| | Target port group descriptor (see Table 5) [last] | | | | | | | |
| . . . | | | | | | | | |
| n | | | | | | | | |

In Table 3, the RETURN DATA LENGTH field indicates the length in bytes of the list of target port group descriptors. The contents of the RETURN DATA LENGTH field are not altered based on the allocation length. There is one target port group descriptor (see Table 5 below) for each target port group. It is the content of these target port group descriptors that is used in embodiments of the present invention.

In Table 2, the second listed format of data, the extended header format of the parameter data, for the REPORT TARGET PORT GROUPS command is shown in Table 4 below.

TABLE 4

| | Bit | | | | | | | |
|---|---|---|---|---|---|---|---|---|
| Byte | 7 | 6 | 5 | 4 | 3 | 2 | 1 | 0 |
| 0 | (MSB) | RETURN DATA LENGTH (n-3) | | | | | | (LSB) |
| . . . | | | | | | | | |
| 3 | | | | | | | | |
| 4 | Reserved | RTPG_FMT (001b) | | | Reserved | | | |
| 5 | IMPLICIT TRANSITION TIME | | | | | | | |
| 6 | Reserved | | | | | | | |
| 7 | | | | | | | | |
| | Target port group descriptor list | | | | | | | |
| 8 | Target port group descriptor (see table 5) [first] | | | | | | | |
| . . . | | | | | | | | |
| | Target port group descriptor (see table 5) [last] | | | | | | | |
| . . . | | | | | | | | |
| n | | | | | | | | |

In Table 4, the report target port groups format (RTPG_FMT) field indicates the returned parameter data format and is set as shown in Table 4 for the extended header parameter data format. The IMPLICIT TRANSITION TIME field indicates the minimum amount of time in seconds a host 102 should wait prior to timing out an implicit state transition. A value of zero indicates that the implicit transition time is not indicated.

Table 5 below shows the format used for each one of the target port group descriptors referred to in Table 4. Embodiments of the invention may use two or more target port group descriptors. In an embodiment, a target port group descriptor describing ports on the formerly preferred, now non-preferred, node whose removal is anticipated is presented with Active/Non-optimized asymmetric access state, and a target port group descriptor describing ports on the newly preferred, formerly non-preferred, node is presented with Active/Optimized asymmetric access state. Any number of other target port group descriptors may also be returned.

TABLE 5

| | Bit | | | | | | | |
|---|---|---|---|---|---|---|---|---|
| Byte | 7 | 6 | 5 | 4 | 3 | 2 | 1 | 0 |
| 0 | PREF | RTPG_FMT (000b) | | | ASYMMETRIC ACCESS STATE | | | |
| | | | | | (See Table 6) | | | |
| 1 | T_SUP | O_SUP | Reserved | LBD_SUP | U_SUP | S_SUP | AN_SUP | AO_SUP |
| 2 | (MSB) | TARGET PORT GROUP | | | | | | (LSB) |
| 3 | | | | | | | | |
| 4 | Reserved | | | | | | | |
| 5 | STATUS CODE | | | | | | | |
| 6 | Vendor specific | | | | | | | |
| 7 | TARGET PORT COUNT | | | | | | | |
| | Target port descriptor list | | | | | | | |
| 8 | Target port descriptor (see table 8) [first] | | | | | | | |
| . . . | | | | | | | | |
| 11 | | | | | | | | |
| | . | | | | | | | |
| | . | | | | | | | |
| | . | | | | | | | |
| n − 3 | Target port descriptor (see table 8) [last] | | | | | | | |
| . . . | | | | | | | | |
| n | | | | | | | | |

In Table 5, the first eight bytes of data contain descriptive information about the group of ports 140-146. These eight bytes are followed by a number of 4 byte descriptors, one descriptor being associated with each port 140-146 that the group contains. Embodiments of the present invention are not limited to eight bytes of descriptive data, nor to each descriptor being four bytes in length. Whilst a port 140-146 group could contain ports 140-146 of any type, in practice a particular port 140-146 group corresponds to all the ports 140-146 of a particular type, such as Serial Attached SCSI (SAS), Fibre Channel or virtual Fibre Channel on a particular node 120, 124 in the storage controller 110. A preferred target port (PREF) bit set to one indicates that the primary target port group is a preferred primary target port group for accessing the addressed virtualized disk 130, 132. A PREF bit set to zero indicates the primary target port group is not a preferred primary target port group. The RTPG_FMT field indicates the returned parameter data format and shall be set as shown in table 5 for the target port group descriptor format.

In Table 5, the ASYMMETRIC ACCESS STATE field (see Table 6 below) contains the target port group's target port asymmetric access state. Some of the possible values for this field are summarized in the table below. Other values may possible, but are not relevant for the purposes of embodiments of the present invention.

TABLE 6

| Codes | States | Type |
|---|---|---|
| 0h | Active/Optimized | Primary |
| 1h | Active/Non-Optimized | Primary |
| 2h | Standby | Primary |
| 3h | Unavailable | Primary |
| 4h | Logical block dependent | Primary |
| 5h to Dh | Reserved | |
| Eh | Offline | Secondary |
| Fh | Transitioning between states | Primary |

In Table 5, the TARGET PORT COUNT field indicates the number of target ports 140-146 that are in that target port group and the number of target port descriptors in the target port group descriptor. Every target port group shall contain at least one target port 140-146. The target port group descriptor shall include one target port descriptor for each target port in the target port group.

The format of each target port descriptor is shown in table 7.

TABLE 7

| | Bit | | | | | | | |
|---|---|---|---|---|---|---|---|---|
| Byte | 7 | 6 | 5 | 4 | 3 | 2 | 1 | 0 |
| 0 | Reserved | | | | | | | |
| 1 | | | | | | | | |
| 2 | (MSB) | RELATIVE TARGET PORT IDENTIFIER | | | | | | (LSB) |
| 3 | | | | | | | | |

In Table 7, the RELATIVE TARGET PORT IDENTIFIER field indicates a relative port identifier of a target port in the target port group.

As described above, virtualized disks 130, 132 may be accessible through to multiple nodes 120, 124, each of the nodes having a respective target port group 180-184. Virtualized disks 130, 132 support asymmetric logical unit access if different ones of the target port groups 180-184 may be in different target port asymmetric access states.

When in an Active/Optimized state, that is having an ASYMMETRIC ACCESS STATE field value of 0 h, the target port group 180-184 should be capable of accessing the virtualized disk 130, 132. Commands sent from the storage controller 110 to the virtualized disk 130, 132 should operate as specified in the appropriate command set standards. When in an Active/Non-Optimized state, that is having an ASYMMETRIC ACCESS STATE field value of 1 h, the target port group 180-184 should also be capable of accessing the virtualized disk 130, 132. Commands sent from the storage controller 110 to the virtualized disk 130, 132 should operate as specified in the appropriate command set standards. However, the execution of certain commands, especially those involving data transfer or caching, may operate with lower performance than they would if the target port group 180-184 were in the Active/Optimized state.

When in a “Standby” state, all target ports 180-184 in a target port group are capable of performing a limited set of commands. The standby state is intended to provide a state from which it should be possible to provide a higher level of accessibility, should this become necessary for any reason, to a virtualized disk 130, 132 by transitioning to either the Active/Optimized or the Active/Non-Optimized states. In practice, the commands that operate in the standby state are those necessary for diagnosing and testing the virtualized disk 130, 132 paths 162-174, identifying the path 162-174, identifying the virtualized disk 130, 132, determining the operational state of the virtualized disk 130, 132, determining the active/inactive state of the virtualized disk 130, 132, managing or removing the virtualized disk 130, 132 or element reservations and testing the service delivery subsystem. When in an “Unavailable” state, only a limited set of commands specified in the appropriate command set standards are accepted. The unavailable state is intended for the situation when the target port accessibility to a virtualized disk 130, 132 may be severely restricted due to, for example, a hardware error and therefore it may not be possible to transition from this state to either the active/optimized, active/non-optimized or standby states.

At step 306, host 102 waits for an “Asymmetric Access State Changed” unit attention notification. At step 308, host 102 directs new input/output through now preferred ports 144, 146 on the second node 124. The computer-implemented method ends at step 310.

FIG. 4 is a flow chart of the steps performed by the storage controller 110 after the host 102 has completed the steps of FIG. 3. The computer-implemented method starts at step 402. At step 404, the storage controller 110 waits until all pending operations to the first node 120 are completed. In an embodiment, the storage controller 110 removes the first node 120 when it determined that the host 102 is utilizing the second node 124. This determination may be by tracking all of the operations which are pending and then checking that all of the pending operations have been completed. In another embodiment, the storage controller 110 removes the first node 120 after a predetermined period of time. It may assume that all of the pending operations have completed. The predetermined period of time has to be sufficient for the host 102 to see and respond to the “Asymmetric Access State Changed” unit attention notification. At step 406, the first node 120 is removed. The computer-implemented method ends at step 408.

If and when the node 120, 124 is to be reinstated, then the state of the node 120, 124 are set to be non-preferred, that is target port groups corresponding to target ports belonging to that node are reported with an Active/Non-optimized ASYMMETRIC ACCESS STATE bit. The relevant configuration information for the timely servicing of host 102 I/O is then downloaded to the node 120 as is known in the prior art. Once this has been completed, then the state of the node may be set to preferred and the ASYMMETRIC ACCESS STATE bit of the port groups of the node 120, 124 are set to Active/Optimized, where this is appropriate, i.e. where these ports 140-146 are to be preferred or where this node 120, 124 is the preferred route for accessing a virtualized disk 130, 132 during normal operations.

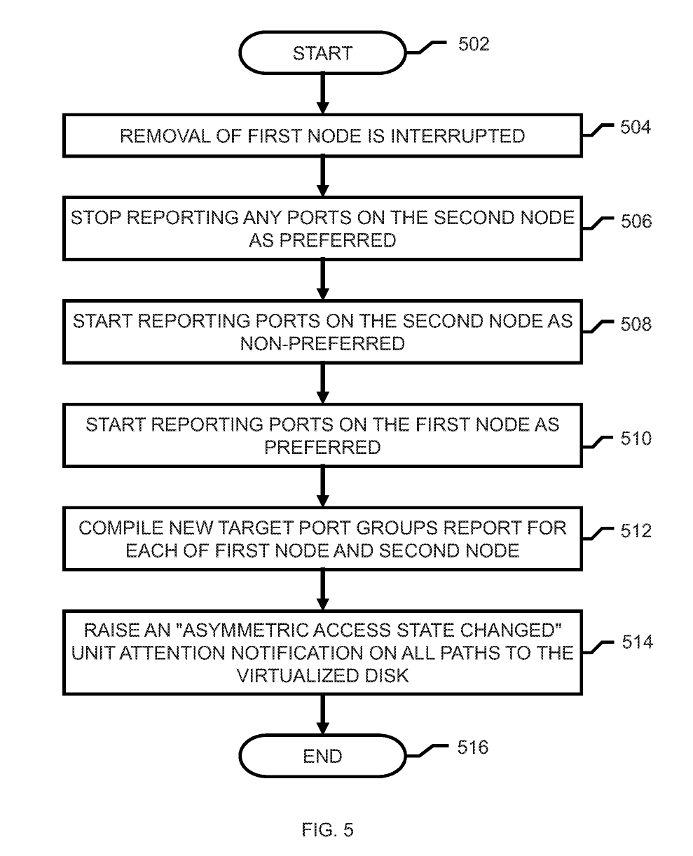

FIG. 5 is a flow chart of steps performed in the event that removal of a first node 120 is interrupted. The computer-implemented method starts at step 502. At step 504, removal of the first node 120 is interrupted. At step 506, any ports 140-146 on the second node 124 are no longer reported as preferred. At step 508, ports 140-146 on the second node 124 are now reported as non-preferred. At step 510, ports 140-146 on the first node 120 are now reported as preferred. At step 512, a new target ports group report is compiled for each of the first node 120 and the second node 124. At step 514, an “Asymmetric Access State Changed” unit attention notification is raised on all paths to the virtualized disks 130, 132. The computer-implemented method ends at step 516.

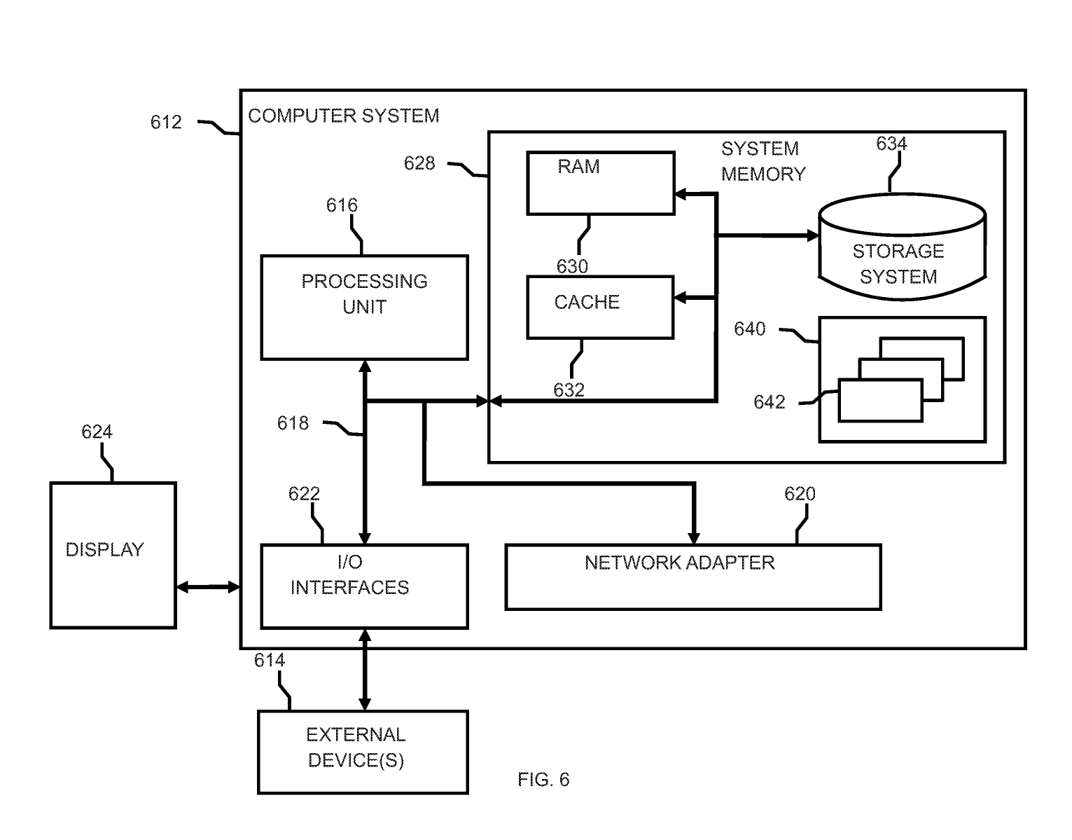

Referring now to FIG. 6, a schematic of an example of computing system is shown. Computing system 612 is only one example of a suitable computing system and is not intended to suggest any limitation as to the scope of use or functionality of embodiments of the invention described herein. Regardless, computing system 612 is capable of being implemented and/or performing any of the functionality set forth hereinabove.

Computer system/server 612 is operational with numerous other general purpose or special purpose computing system environments or configurations. Examples of well-known computing systems, environments, and/or configurations that may be suitable for use with computer system/server 612 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 612 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 612 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 612 is shown in the form of a general-purpose computing device. The components of computer system/server 612 may include, but are not limited to, one or more processors or processing units 616, a system memory 628, and a bus 618 that couples various system components including system memory 628 to processor 616.

Bus 618 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 612 typically includes a variety of computer system readable media. Such media may be any available media that is accessible by computer system/server 612, and it includes both volatile and non-volatile media, removable and non-removable media.

System memory 628 can include computer system readable media in the form of volatile memory, such as random access memory (RAM) 630 and/or cache memory 632. Computer system/server 612 may further include other removable/non-removable, volatile/non-volatile computer system storage media. By way of example only, storage system 634 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 618 by one or more data media interfaces. As will be further depicted and described below, system memory 628 may include at least one program product having a set (e.g., at least one) of program modules that are configured to carry out the functions of embodiments of the invention.

Program/utility 640, having a set (at least one) of program modules 642, may be stored in system memory 628 by way of example, and not limitation, as well as an operating system, one or more application programs, other program modules, and program data. Each of the operating system, one or more application programs, other program modules, and program data or some combination thereof, may include an implementation of a networking environment. Program modules 642 generally carry out the functions and/or methodologies of embodiments of the invention as described herein.

Computer system/server 612 may also communicate with one or more external devices 614 such as a keyboard, a pointing device, a display 624, etc.; one or more devices that enable a user to interact with computer system/server 612; and/or any devices (e.g., network card, modem, etc.) that enable computer system/server 612 to communicate with one or more other computing devices. Such communication can occur via Input/Output (I/O) interfaces 622. Still yet, computer system/server 612 can communicate with one or more networks such as a local area network (LAN), a general wide area network (WAN), and/or a public network (e.g., the Internet) via network adapter 620. As depicted, network adapter 620 communicates with the other components of computer system/server 612 via bus 618. It should be understood that although not shown, other hardware and/or software components could be used in conjunction with computer system/server 612. Examples, include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, column-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, in a storage controller, of changing a preferred node from a first node to a second node, the computer-implemented method comprising:
receiving a notification of a request to remove the first node;
reporting ports on the first node as non-preferred instead of reporting them as preferred;
reporting ports on the second node as preferred instead of reporting them as non-preferred;
compiling a target port groups report for each of the first node and the second node; and
raising an “Asymmetric Access State Changed” unit attention notification.

2. The computer-implemented method of claim 1, wherein access to logical units (LUNs) presented by the storage controller supports Asymmetric Logical Unit Access and wherein each target port group corresponding to ports on the first node and the second node have different asymmetric access states.

3. The computer-implemented method of claim 1, wherein non-preferred ports correspond to ports in a port group with an “Active/Non-Optimized” asymmetric access state and preferred ports correspond to ports in a port group with an “Active/Optimized” asymmetric access state.

4. The computer-implemented method of claim 1, wherein a host has access to the storage controller and in response to a unit attention condition being established:
the host issues a “Report Target Port Group” command;
the host waits for the “Asymmetric Access State Changed” unit attention notification;
the host receives and directs new input/output to the second node; and
the storage controller removes the first node.

5. The computer-implemented method of claim 4, wherein the storage controller removes the first node after a predetermined period of time.

6. The computer-implemented method of claim 4, wherein the storage controller removes the first node when it determined that the host is utilizing the second node.

7. The computer-implemented method of claim 1, wherein, responsive to receiving a notification of cancellation of the request to remove the first node, further comprising:
reporting ports on the second node as non-preferred instead of reporting them as preferred;
reporting ports on the first node as preferred instead of reporting them as non-preferred;
compiling a target port groups report for each of the first node and the second node; and
raising the “Asymmetric Access State Changed” unit attention notification.

8. A storage controller comprising:
a first node and a second node, each of the first node and the second node have a plurality of ports;
the storage controller receiving a notification of a request to remove the first node;
the storage controller changing a preferred node from the first node to the second node by:
reporting ports on the first node as non-preferred instead of reporting them as preferred;
reporting ports on the second node as preferred instead of reporting them as non-preferred;
compiling a target port groups report for each of the first node and the second node; and
raising an “Asymmetric Access State Changed” unit attention notification.

9. The storage controller of claim 8, wherein access to logical units (LUNs) presented by the storage controller supports Asymmetric Logical Unit Access and wherein each target port group corresponding to ports on the first node and the second node have different asymmetric access states.

10. The storage controller of claim 8, wherein non-preferred ports correspond to ports in a port group with an “Active/Non-Optimized” asymmetric access state and preferred ports correspond to ports in a port group with an “Active/Optimized” asymmetric access state.

11. The storage controller of claim 8, wherein a host has access to the storage controller and in response to a unit attention condition being established:
the host issues a “Report Target Port Group” command to the storage controller;
the host waits for the “Asymmetric Access State Changed” unit attention notification;
the host directs new input/output to the second node; and
the storage controller removes the first node.

12. The storage controller of claim 11, wherein the storage controller removes the first node after a predetermined period of time.

13. The storage controller of claim 11, wherein the storage controller removes the first node when it determines that the host is utilizing the second node.

14. The storage controller of claim 8, wherein, responsive to receiving a notification of cancellation of the request to remove the first node, the storage controller:
reports ports on the second node as non-preferred instead of reporting them as preferred;
reports ports on the first node as preferred instead of reporting them as non-preferred;
compiles a target port groups report for each of the first node and the second node; and
raising the “Asymmetric Access State Changed” unit attention notification.

15. A computer program product for changing a preferred node in a storage controller from a first node to a second node, the computer program product comprising:
a computer readable storage medium having program instructions embodied therewith, the program instructions executable by a computer to cause the computer to:
receive a notification of a request to remove the first node;
report ports on the first node as non-preferred instead of reporting them as preferred;
report ports on the second node as preferred instead of reporting them as non-preferred;
compile a target port groups report for each of the first node and the second node; and
raising an “Asymmetric Access State Changed” unit attention notification.

16. The computer program of claim 15, wherein access to logical units (LUNs) presented by the storage controller supports Asymmetric Logical Unit Access and wherein each target port group corresponding to ports on the first node and the second node have different asymmetric access states.

17. The computer program of claim 15, wherein non-preferred ports correspond to ports in a port group with an “Active/Non-Optimized” asymmetric access state and preferred ports correspond to ports in a port group with an “Active/Optimized” asymmetric access state.

18. The computer program of claim 15 wherein a host has access to the storage controller and in response to a unit attention condition being established:
the host issues a “Report Target Port Group” command;
the host waits for the “Asymmetric Access State Changed” unit attention notification;
the host directs new input/output to the second node; and
the storage controller removes the first node.

19. The computer program of claim 16, wherein the storage controller removes the first node after a predetermined period of time.

20. The computer program of claim 19, wherein the storage controller removes the first node when it determined that the host is utilizing the second node.

21. The computer program of claim 16, wherein, responsive to receiving a notification of cancellation of the request to remove the first node, further comprises:
reporting ports on the second node as non-preferred instead of reporting them as preferred;
reporting ports on the first node as preferred instead of reporting them as non-preferred;
compiling a target port groups report for each of the first node and the second node; and
raising the “Asymmetric Access State Changed” unit attention notification.
